(19) United States
(12) Patent Application Publication
(10) Pub. No.: US 2016/0240332 A1
(43) Pub. Date: Aug. 18, 2016

(54) SWITCH APPARATUS AND MANUFACTURING METHOD THEREOF

(71) Applicant: Microsoft Technology Licensing, LLC, Redmond, WA (US)

(72) Inventors: Chong Chen, Beijing (CN); Wuyang Huang, Beijing (CN); Lei Fan, Beijing (CN); Qingchun Liu, Beijing (CN)

(21) Appl. No.: 14/969,383

(22) Filed: Dec. 15, 2015

(30) Foreign Application Priority Data
Feb. 16, 2015 (CN) 2015021600399310

(51) Int. Cl. H01H 13/14; H01H 11/00

(52) U.S. Cl. CPC H01H 13/14; H01H 11/00; H01H 2235/006

(57) ABSTRACT

A switch and a method of manufacturing the switch are provided. In one embodiment, the switch comprises a switch assembly adapted to receive a first force in a first direction; and a protective member arranged on a substrate and adapted to receive the switch assembly, the protective member comprising a spring portion applying a second force to the switch assembly in a second direction that is opposite to the first direction, the switch assembly being adapted to be moved relative to the substrate in response to the first force exceeding a predefined threshold value. The switch is capable of absorbing excessive energy by a force applied on the switch, thus preventing the excessive energy breaking the substrate to which the switch is mounted.

### RELATED APPLICATIONS

This application claims priority to International Application No. 2015021600399310, filed on Feb. 16, 2015, and entitled “SWITCH APPARATUS AND MANUFACTURING METHOD THEREOF.” This application claims the benefit of the above-identified application, and the disclosure of the above-identified application is hereby incorporated by reference in its entirety as if set forth herein in full.

### BACKGROUND

A switch may be used to open or close a portion of a circuit is rigidly fixed onto a substrate. For example, a typical mobile device may include a few switches located laterally on the device for adjusting volume, switching on/off the device, and the like.

### BRIEF DESCRIPTION OF THE DRAWINGS

FIG. 1 illustrate a block diagram of a switch according to one embodiment of the subject matter described herein;

FIG. 2 illustrates a perspective view of a switch according to one embodiment of the subject matter described herein;

FIG. 3 illustrates a exploded view of the switch as illustrated in FIG. 2 according to one embodiment of the subject matter described herein;

FIG. 4 illustrates a sectional view of the switch as illustrated in FIG. 2 according to one embodiment of the subject matter described herein;

FIG. 5 illustrates a side view of the switch as illustrated in FIG. 2 according to one embodiment of the subject matter described herein;

FIG. 6 illustrates a top view of the switch as illustrated in FIG. 2 which is connected to a substrate of an electronic device according to one embodiment of the subject matter described herein; and

FIG. 7 illustrates a flowchart of a method of manufacturing the switch in accordance with embodiments of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “includes” and its variants are to be read as opened terms that mean “includes, but is not limited to.” The term “or” is to be read as “and/or” unless the context clearly indicates otherwise. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

A switch may be implemented as a component protruding from the housing of the device. In some instances, a force that is much larger than the minimum actuation force may be applied to the switch, for example, when the device is dropped onto the floor. A user typically applies a normal force to the switch of a mobile device at or below 5N. The impact on the switch as the device drops on the floor, however, can reach a level of 80N. Such an excessive force would probably damage the substrate or detach the switch from the substrate.

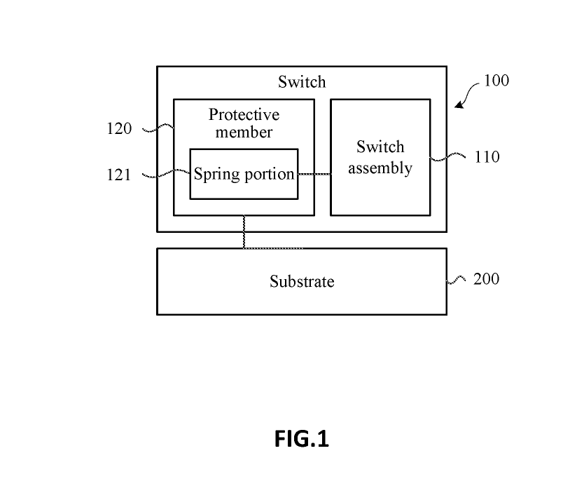

FIG. 1 illustrates a block diagram of a switch 100 according to one embodiment of the subject matter described herein. It is to be understood that the switch 100 is described only for the purpose of illustration, without suggesting any limitations as to the scope of the subject matter described herein. Different embodiments with different structures can realize the purpose and concept of the subject matter described herein.

As shown, the switch 100 includes a switch assembly 110 adapted to receive a force in a certain direction. The force applied on the switch assembly 110 is referred to as the “first force,” and the direction of the first force is referred to as the “first direction”. The first force may be applied by a user operating the switch 100 and/or by another actuator operated in response to a certain command.

The switch 100 further includes a protective member 120 arranged on a substrate 200 and adapted to receive the switch assembly 110. The protective member 120, among other things, includes a spring portion 121 which applies a force to the switch assembly 110 in a direction that is essentially opposite to the first direction. The force applied by the spring portion 121 is referred to as the “second force,” and the direction of the second force is referred to as the “second direction”.

In accordance with embodiments of the subject matter described herein, the switch assembly 110 is not rigidly fixed to the substrate 200 of the hosting device. Instead, if the first force exceeds a predefined threshold value, the switch assembly 110 can be moved relative to the substrate 200.

In this configuration, the second force is pre-loaded in the second direction. As a result, in the case that the first force is smaller than the second force, the switch assembly 110 will not be moved. However, if the first force is larger than the predefined threshold value, the spring portion 121 will be deformed which will in turn cause the switch assembly 110 to be moved in the first direction. As the first force increases, the spring portion 121 is further deformed and the switch assembly 110 is further moved. The deformation of the spring portion 121 absorbs excessive energy by the first force and thus avoids the direct impact to the substrate 200. In addition, the resulting shear stress on the connectors, such as pins that may couple the switch 100 onto the substrate 200, can be significantly reduced.

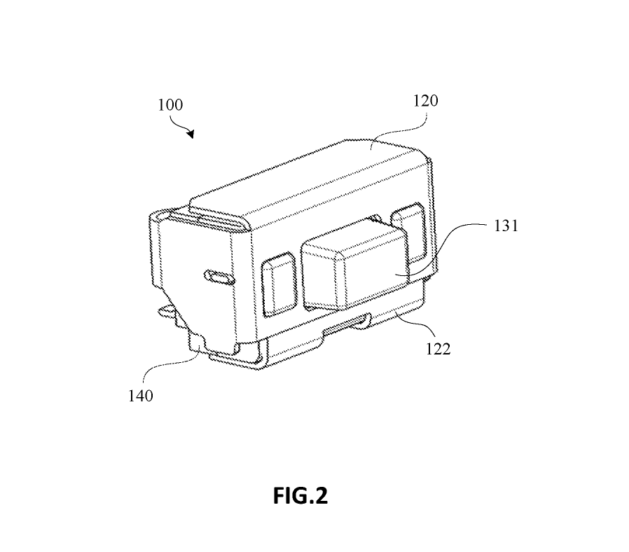

With reference to FIG. 2, a perspective view of an implementation of the switch 100 according to one embodiment of the subject matter described herein is shown. In this implementation, the protective member 120 of the switch 100 receives a button housing 140. The switch 100 comprises a pressing member 131 that is constrained by the button housing 140. For example, the pressing member 131 may be contained in the button housing 140 and allowed to be moved relative to the button housing 140 in response to a force applied on the pressing member 131.

As shown, the protective member 120 further includes a fixing portion 122 that couples or connects the protective member 120 onto a substrate (not shown). In one embodiment, the connection between the protective member 120 and the substrate may be rigid. For example, soldering or interference fit may be used to couple the protective member 120 to the substrate. As a result, the switch 100 as a whole is also connected to the substrate as shown in FIG. 2 when there is no force exerted on the switch 100. Of course, the flexible coupling is possible as well, depending on the specific application or requirement, for example.

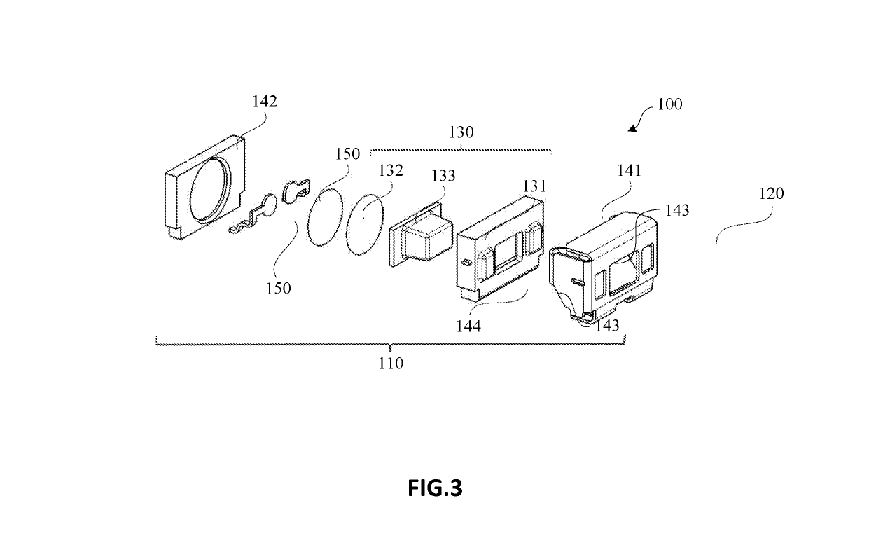

FIG. 3 shows an exploded view of the components of the switch 100 as illustrated in the embodiment of FIG. 2. In the embodiment as shown in FIG. 3, in addition to components as shown in FIG. 2, the switch 100 further includes a front housing 141, a film member 133, a resisting member 132, a pair of contacts 150 and a rear housing 142.

Each of the front housing 141 and the rear housing 142 is a part of the button housing 140, which constrains the movement of the pressing member 131 as discussed above. Each of the pressing member 131, the film member 133, and the resisting member 132 is a part of the button assembly 130 capable of being operated by an end user. In one embodiment, the film member 133 is a wear resistant part used to reduce impact directly onto the resisting member 132. The resisting member 132 may be used to electrically connect the pair of the contacts 150 coupled to the substrate responsive to the resisting member 132 being deformed to a certain extent, and the deformed resisting member 132 in turn switches on a circuit on the substrate. The front housing 141, the pressing member 131, the film member 133, the resisting member 132, the pair of contacts 150 and the rear housing 142 forms a switch assembly 110 allowed to be moved relative to the protective member 120 in response to the first force exceeding the predefined threshold value. The functionalities of these components will be detailed below.

As mentioned above, in one embodiment, the film member 133 can be made of wear-resistant materials in order to protect the resisting member 132 from dust and dirt. In addition, the film member 133 may be used to reduce impact directly onto the resisting member 132 and thus prolong the life span of the switch. The switch 100 may operate with or without the film member 133.

The contacts 150 are used to control the status of the switch 100. Particularly, the switch 100 will be closed when the pair of contacts 150 is electrically connected and will be opened when the pair of contacts 150 is electrically disconnected. Although only a single pair of switches is shown in FIG. 3, other implementations are possible that include additional or different types of switches. There can be any suitable number of pairs of contacts in the switch 100.

In one embodiment, the contacts 150 can be made of a conductive material, such as copper, which has an excellent conductivity and toughness. Additionally or alternatively, the protective member 120 may be made of metal material such as copper, which is tough. The button housing 140 including the front housing 141 and the rear housing 142 and the pressing member 131 may be made of insulating materials, for example.

In another embodiment, the contacts 150 and the resisting member 132 can be plated with gold, which provides great signal transmission properties, mating durability, and excellent oxidation resistance against polluted environments. Additionally, the contacts 150 and the resisting member 132 can also be plated with nickel beneath the gold layer acting as a diffusion barrier. Alternatively, silver can be plated for applications where low intermodulation is required, and chrome can be plated for connectors used in harsh environment such as in military applications.

The above examples are described only for the purpose of illustration, without suggesting any limitations as to the scope of the subject matter described herein. Any additional or alternative materials can be used to make the components of the switch.

As discussed above, the protective member 120 can prevent the damage caused by excessive force. Without the protective member 120, the button housing 140 cannot be moved relative to the substrate. Thus an excessive force exerted on the pressing member 131 will be mostly transmitted to the substrate and the resulting shear stress on connectors such as pins of the switch may be destructive when the force is too large, for example larger than 80N, as described above. By use of the protective member 120 which allows relative movement of the switch assembly 110 with respect to the substrate, the potential damage can be eliminated.

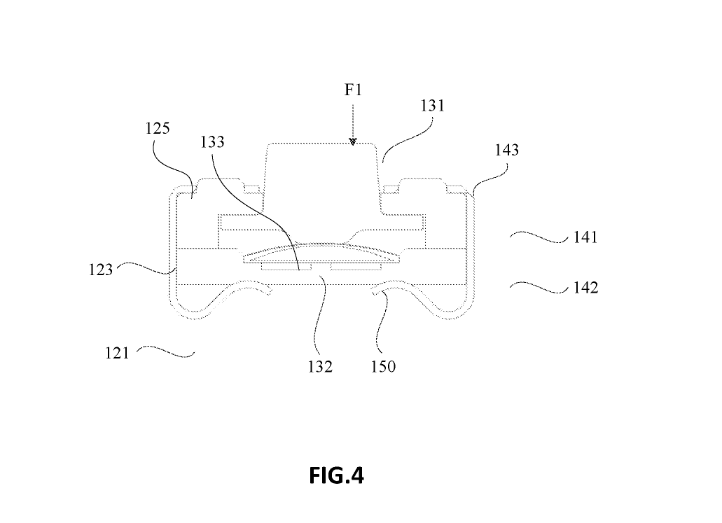

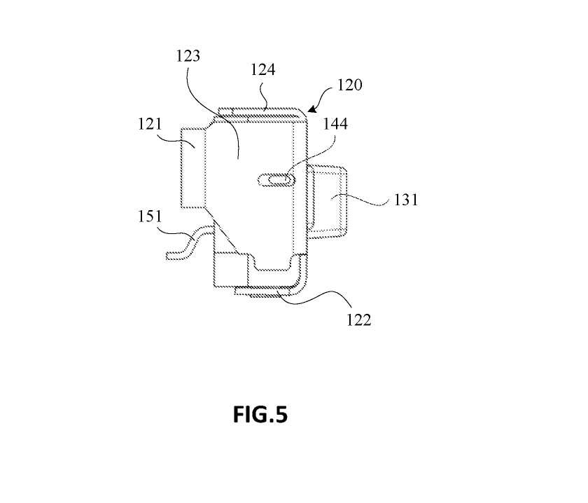

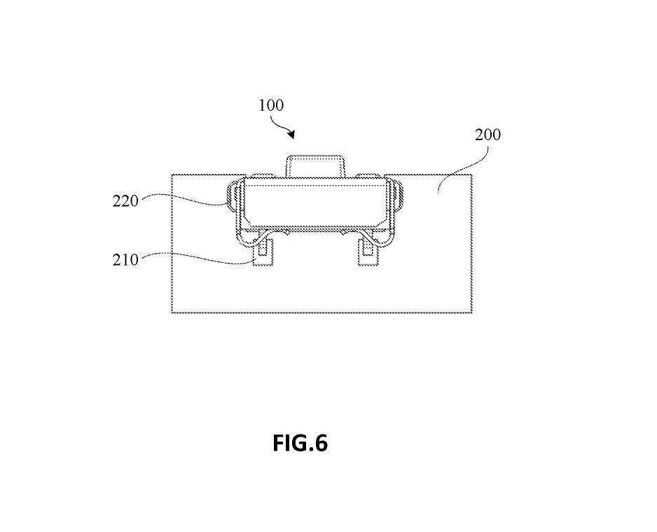

FIGS. 4 and 5 illustrate a sectional view and a side view of the switch 100 as shown in FIGS. 2 and 3, respectively. FIG. 6 illustrates a top view of the switch 100 according to the embodiment of the subject matter described herein as shown in FIGS. 2 and 3 being connected to a substrate of an electronic device. Although the switches as shown in FIGS. 4 to 6 are of the same size and shape, it is to be understood that this particular example of the switch can be made and shaped differently.

With reference to FIGS. 4 and 5, as shown, the switch assembly 110 is received and constrained in the protective member 120. In one embodiment, the protective member 120 may be shaped to have a front panel 125 enabling the pressing member 131 protruding out of the protective member 120. In addition to the fixing portion 122, the protective member 120 may further include two opposite side walls 123 and a top wall 124. Furthermore, in the shown embodiment, the spring portion 121 of the protective member 120 is implemented as two curved spring pieces 121 that are located opposite to the front panel 125. The protective member 120 defined by the front panel 125, the spring portions 121, the fixing portion 122, the side walls 123 and the top wall 124 are together used to define a container in which the switch assembly 110 can be fitted.

In one embodiment, a front positioning portion 143 may be provided on the front housing 141. In one embodiment, the front positioning portion 143 protrudes out of the front panel 125 through an aperture formed on the front panel 125 of the protective member 120. In this way, the front positioning portion 143 allows a close fit between the front housing 141 and the front panel 125 of the protective member 120.

Although two front positioning portions 143 are shown in FIGS. 2 to 4, this is only for the purpose of illustration without suggesting any limitations as to the scope of the subject matter described herein. The front housing 141 may include any suitable number of the front positioning members. Any suitable number may be used to achieve a close fit between the front housing 141 and the front panel 125 of the protective member 120 when the switch assembly 110 is mounted within the protective member 120. Likewise, the shape factor of the front positioning portions 143 is not limited to the example shown in FIGS. 3 and 4.

Additionally or alternatively, in one embodiment as shown in FIGS. 3 and 5, two lateral positioning portions 144 are provided on the front housing 141. Each of the lateral positioning portions 144 may protrude out of a respective aperture formed on each of the side walls 123. The apertures may allow the lateral positioning portions 144 to be moved in a certain direction only. To this end, in one embodiment, the apertures on the side walls 123 may be of an elongated shape. For example, in the example embodiment shown in FIG. 5, the long side of the aperture on the side wall 123 is longer than that of the lateral positioning portion 144, which allows a horizontal movement of the switch assembly 110 with respect to the protective member 120 responsive to a force exceeding the predefined threshold value. The movement will be described in detail in the following paragraphs. Movement in any other suitable direction is possible as well.

Although two lateral positioning portions 144 are provided for the particular example as shown in FIGS. 3 and 5, this is only for the purpose of illustration without suggesting any limitations as to the scope of the subject matter described herein. The front housing 141 may include any suitable number of the lateral positioning portions to achieve a guided movement along the first and second directions when the switch assembly 110 is mounted within the protective member 120. Likewise, the shape factor of the lateral positioning portions 144 is not limited to the example shown in FIGS. 3 and 5.

In one embodiment, the spring portions 121 may be already compressed against the rear housing 142 when the switch assembly 110 is mounted in the protective member 120. In other words, at this point, the second force has been applied by the compressed spring portions 121 to the rear housing 142, or the entire switch assembly 110. Such pre-loaded second force pushes the switch assembly as a whole against the front panel 125 of the protective member 120. As a result, the front housing 141 and the rear housing 142 are closely positioned within the protective member 120.

The particular embodiment shown in FIG. 4 includes flat surfaces on the front housing 141 and the rear housing 142 in contact with each other so that the front housing 141 and the rear housing 142 can be closely positioned. Additional fittings may be provided for fixing the front housing 141 to the rear housing 142. The subject matter described herein is not limited to the form of these surfaces beyond that fact that they allow the front housing 141 to be securely matched with the rear housing 142.

Although the button housing 140 of the particular example shown in FIG. 4 includes both the front housing 141 and the rear housing 142, in other examples, the button housing 140 may include any suitable number of components. The component(s) can restrict the movement of the button assembly 130 in the first and second directions. For example, the button housing may be formed integrally with only one component or may be formed with more than two components in some other implementations.

In one embodiment, as shown in FIG. 4, a chamber may be formed within the button housing 140 for containing the button assembly 130, namely, the pressing member 131, the resisting member 132, and the film member 133.

In one embodiment, the pressing member 131 can be made in the form of a plunger to be pressed by the first force denoted as “F1” in FIG. 4. The pressing member 131 may be any shape or size such that a portion of it protrudes out of an opening on the front housing 141 for being pressed while the remainder of it can be confined by the front housing 141 so that the pressing member 131 can be held by the front housing 141.

In one embodiment, the resisting member 132 can be made in the form of a dome, which can be elastically deformed in response to a force larger than a certain value. In this example embodiment, the resisting member 132 can be made of an electrically conductive material such as copper. When the first force F1 is large enough to deform the resisting member 132, the resisting member 132 may collapse onto the rear housing 142 after moving for a threshold distance in the first direction. As a result, the contacts 150 received in the rear housing 142 are electrically connected with one another.

In one embodiment, the resisting member 132 may be resilient or elastically deformable such that the resisting member 132 is able to undergo numerous times of deformation process back and forth. The resisting member 132 may be designed to provide a reactive force responsive to the first force. Specifically, the resisting member 132 may provide a force (referred to as “third force”) in the second direction, which is essentially opposite to the first direction as described above, in response to the pair of contacts 150 being electrically connected. When the switch 100 is designed to be used in a mobile phone, by way of example only, the operational force applied by the end user is generally below 10N. Accordingly, the resisting member 132 may be designed to provide the third force of about 3N, for example. In this event, the total force needed to make the resisting member 132 electrically connect the pair of contacts 150 is equal to the third force, no matter if the resisting member 132 is pre-compressed against the front panel 125 or not.

The user does not have to apply the pressing force exactly in the first direction. Instead, the pressing force may be applied with a certain angle with respect to the first direction. In this event, the first force Fl may be the component of the pressing force along the first direction. In one embodiment, the pressing member 131 may be shaped to be confined in the button housing 140 along the direction perpendicular to the first direction, in order to prevent the pressing member 131 from being moved by the component of the pressing force along the perpendicular direction.

In one embodiment, the spring portion 121 may be designed such that the second force provided by the spring portion 121 is larger than the third force. In this way, it is possible to ensure that the first force F1 will deform the resisting member 132 firstly if F1 is larger than the third force. The spring portion 121, however, will not be deformed as long as the first force F1 is smaller than the second force. That is to say, the spring portion 121 may be designed to be deformed only when the first force F1 exceeds a certain value, i.e., the predefined threshold value as described above. Therefore, when the first force is in a range large enough to move the pressing member but not too large to deform the spring portion 121, the switch 100 may be operated normally. Because the first force within this range is not excessive, it may not produce any destructive effect to the switch itself or to the surface to which the switch is fixed. On the other hand, when the first force F1 exceeds the predefined threshold value, the entire switch assembly 110 will be moved in the first direction and thus deform the spring portion 121 to some extent.

As discussed above, in some embodiments, the second force is a predefined and pre-loaded force which has been already applied onto the button housing 140 in the absence of the first force. The pre-loaded second force is advantageous for the reason that a normal operational force applied by the user is usually smaller than the pre-loaded second force. As a result, an excellent tactility comparable to a conventional switch without such a pre-loaded protective mechanism can be achieved. If a pre-loaded force is absent, however, the user pressing the switch may feel that the button is too loose as the button housing 140 and the pressing member 131 may move in the first direction altogether. In addition, the force applied in the first direction needs to gradually increase if the button housing 140 is to be moved for a longer distance in the first direction. During this process, the spring portion 121 can absorb and store energy as it is deformed, and thus the stress will not be significantly increased between the switch and the substrate as the first force F1 increases. As such, the excessive force applied on the pressing member 131 in the first direction will not break the substrate or detach the switch from the substrate.

In one embodiment, the predefined threshold value may be defined as the sum of the second force and the third force. For example, for side buttons of a mobile phone, the second force provided by the pre-compressed spring portion may be around 20N, which is significantly larger than the third force, e.g., 3N. Therefore, the first force will not move the button housing 140 relative to the protective member 120 if it is smaller than 23N. If the first force exceeds 23N, it will move the button housing 140 more or less in the first direction, depending on how large the first force is. If the first force is removed from the pressing member 131, the spring portion 121 and the resisting member 132 will respectively return the button housing 140 and pressing member 131 back to the stage as shown in FIG. 3.

As shown in FIG. 5, in one embodiment, an elastic portion 151 may be provided for each of the contacts 150. The elastic portion 151 is adapted to be elastically deformed as the switch assembly 110 moves relative to the substrate (or the fixing portion 122) in the first direction. The elastic portion 151 may be used to further absorb the energy from the first force, thereby preventing the excessive energy from being transmitted to the substrate.

In some other example embodiments, each of the contacts 150 may be electrically coupled to the substrate in a flexible connection. In this particular configuration, the contacts 150 may be constructed by electric wires which provide no rigidity. As the contacts 150 are flexible, they can be arbitrarily shaped in accordance with any movement of the switch assembly 110, meaning that the first force may not be transmitted to the substrate via the contacts 150.

By means of pre-loaded force provided by the spring portion 121, the switch 100 may be protected when the operational force is relatively large. A large portion of the energy from an impact to the switch 100 can be absorbed instead of being directly transmitted to the substrate, thereby avoiding possible fracture occurring between the switch 100 and the substrate.

As shown in FIG. 6, the switch 100 according to the subject matter described herein may be attached to a substrate 200. For example, the fixing portions 122 may be fixed to the substrate 200 through fixing holes 220 by way of soldering or interference fit, and the ends of the contacts 150 may be fixed to the substrate 200 through contact holes 210 by way of soldering.

It is to be understood that “top”, “bottom”, “front”, “rear”, “side”, “lateral” and the like are only used to describe the relationship between the components in the figures, instead of limiting their orientation or positioning. For example, in FIG. 6, the switch 100 can be seen as being placed above the substrate 200, and can also be seen as being placed underneath the substrate 200. In addition, although the spring portion 121 as shown by FIGS. 3 to 6 is placed at the rear side of the switch 100, it can be understood that a spring portion placed aside the switch 100 holding the rear housing 142 may also work.

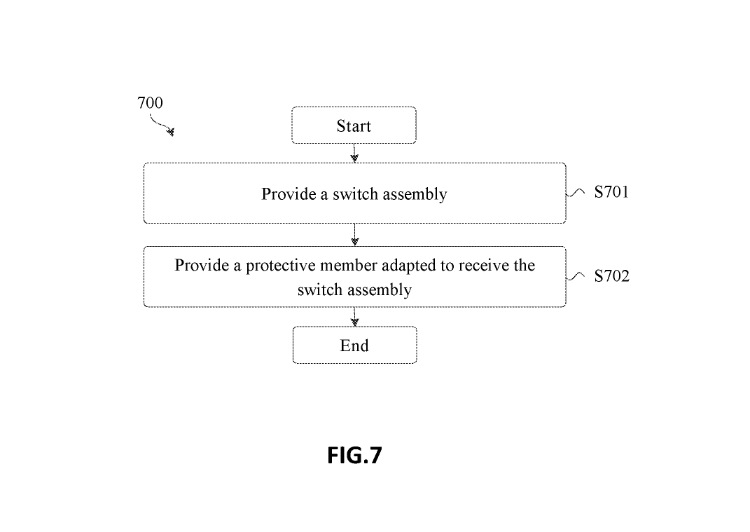

With reference to FIG. 7, it illustrates a block diagram of a method 700 of manufacturing the switch 100 in accordance with embodiments of the subject matter described herein. The method 700 is entered at step S701, where a switch assembly is provided. The switch assembly is adapted to receive a first force in a first direction can be provided.

At step S702, a protective member arranged on a substrate and adapted to receive the switch assembly is provided. The protective member comprising a spring portion applying a second force to the switch assembly in a second direction that is opposite to the first direction. The switch assembly can be moved relative to the substrate in response to the first force exceeding a predefined threshold value.

In one embodiment, providing the switch assembly at step S701 comprises providing a button assembly, the button assembly comprising a pressing member adapted to receive the first force, and providing a button housing adapted to receive the button assembly, where the pressing member is adapted to be moved relative to the button housing in the first direction responsive to the first force.

Additionally or alternatively, providing the switch assembly at the step S701 may comprise providing at least one pair of contacts received in the button housing, and providing a resisting member adapted to electrically connect the pair of contacts in response to the pressing member moving in the first direction for a threshold distance. As discussed above, in one embodiment, the resisting member is adapted to provide a third force in the second direction in response to the pair of contacts being electrically connected. Specifically, the resisting member may be adapted to provide the third force that is less than the second force. In one embodiment, the protective member may be integrally made of metal, for example.

In one embodiment, the method 700 may comprise a step of providing each of the contacts electrically coupled to the substrate by a flexible connection (not shown). Alternatively or additionally, in one embodiment, the method 700 may comprise steps of electrically coupling the pair of contacts to the substrate and providing an elastic portion on each of the contacts. The elastic portion is adapted to be elastically deformed as the switch assembly moves relative to the substrate in the first direction, each of the contacts being electrically connected to the substrate through the elastic portion.

While operations are depicted in a particular order in the above descriptions, this should not be understood as requiring that such operations be performed in the particular order shown or in sequential order, or that all illustrated operations be performed, to achieve desirable results. In certain circumstances, multitasking and parallel processing may be advantageous. Likewise, while several details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A switch comprising:
a switch assembly adapted to receive a first force in a first direction; and
a protective member arranged on a substrate and adapted to receive the switch assembly, the protective member comprising a spring portion applying a second force to the switch assembly in a second direction that is opposite to the first direction,
the switch assembly being adapted to be moved relative to the substrate in response to the first force exceeding a predefined threshold value.

2. The switch according to claim 1, wherein the switch assembly comprises:
a button assembly comprising a pressing member adapted to receive the first force; and
a button housing adapted to receive the button assembly, the pressing member being adapted to be moved relative to the button housing in the first direction responsive to the first force.

3. The switch according to claim 2, wherein the switch assembly comprises a pair of contacts received in the button housing, and the button assembly comprises a resisting member adapted to electrically connect the pair of contacts in response to the pressing member moving in the first direction for a threshold distance.

4. The switch according to claim 3, wherein the resisting member provides a third force in the second direction in response to the pair of contacts being electrically connected.

5. The switch according to claim 3, wherein the pair of contacts is electrically and flexibly coupled to the substrate.

6. The switch according to claim 3, wherein the pair of contacts is electrically coupled to the substrate, and wherein each of the contacts comprises an elastic portion adapted to be elastically deformed as the switch assembly moves relative to the substrate in the first direction, each of the contacts being electrically coupled to the substrate through the elastic portion.

7. The switch according to claim 4, wherein the second force is larger than the third force.

8. The switch according to claim 4, wherein the predefined threshold value is equal to a sum of the second force and the third force.

9. The switch according to claim 1, wherein the protective member is integrally made of metal.

10. The switch according to claim 1, wherein the protective member comprises a fixing portion adapted to rigidly fix the protective member to the substrate.

11. A method of manufacturing a switch comprising:
providing a switch assembly adapted to receive a first force in a first direction; and
providing a protective member arranged on a substrate and adapted to receive the switch assembly, the protective member comprising a spring portion applying a second force to the switch assembly in a second direction that is opposite to the first direction,
the switch assembly being adapted to be moved relative to the substrate in response to the first force exceeding a predefined threshold value.

12. The method according to claim 11, wherein providing the switch assembly comprises:
providing a button assembly, the button assembly comprising a pressing member adapted to receive the first force; and
providing a button housing adapted to receive the button assembly, the pressing member being adapted to be moved relative to the button housing in the first direction responsive to the first force.

13. The method according to claim 12, wherein providing the button assembly comprises:
providing a pair of contacts received in the button housing;
providing a resisting member adapted to electrically connect the pair of contacts in response to the pressing member moving in the first direction for a threshold distance.

14. The method according to claim 13, wherein providing the resisting member comprises:
providing the resisting member that is adapted to provide a third force in the second direction in response to the pair of contacts being electrically connected.

15. The method according to claim 13, further comprising:
electrically coupling the pair of contacts to the substrate by a flexible connection.

16. The method according to claim 13, further comprising:
electrically coupling the pair of contacts to the substrate; and
providing an elastic portion on each of the contacts, the elastic portion being adapted to be elastically deformed as the switch assembly moves relative to the substrate in the first direction, each of the contacts being electrically connected to the substrate through the elastic portion.

17. The method according to claim 14, wherein the resisting member is adapted to provide the third force that is less than the second force.

18. The method according to claim 14, wherein the predefined threshold value is equal to a sum of the second force and the third force.

19. The method according to claim 1, wherein providing the protective member comprises:
providing the protective member that is integrally made of metal.

20. A switch apparatus, comprising:
a switch assembly adapted to receive a first force in a first direction, the switch assembly comprising a button assembly, a button housing adapted to receive the button assembly, and a pair of contacts received in the button housing; and
a protective member arranged on a substrate and adapted to receive the switch assembly,
the button assembly comprising:
a pressing member adapted to receive the first force from a first side of the button housing; and
a resisting member adapted to electrically connect the pair of contacts in response to the pressing member moving in the first direction for a threshold distance, the resisting member providing a third force in a second direction that is opposite to the first direction in response to the pair of contacts being electrically connected, and
each of the contacts comprising an elastic portion adapted to be elastically deformed as the switch assembly moves relative to the substrate in the first direction, each of the contacts being electrically connected to the substrate through the elastic portion, and
the protective member comprising a spring portion applying a second force larger than the third force to the switch assembly in the second direction, a second side of the button housing that is opposite to the first side being adapted to receive the second force, and the switch assembly being adapted to be moved relative to the substrate in response to the first force exceeding a sum of the second force and the third force.
